(19) United States
(12) Patent Application Publication
(10) Pub. No.: US 2009/0087509 A1
(43) Pub. Date: Apr. 2, 2009

(54) MULTI-GATE REACTION INJECTION ASSEMBLY FOR USE WITH A CLOSED MOLD FOR MIXING AND SETTING ISO AND POLY FLUID BASED POLYMERS & PLASTICS WITH ONE OR MORE AGGREGATE FILLER MATERIALS

(76) Inventor: Miguel Linares, Bloomfield Hills, MI (US)

Correspondence Address: GIFFORD, KRASS, SPRINKLE,ANDERSON & CITKOWSKI, P.C, PO BOX 7021, TROY, MI, 48007-7021, US

(21) Appl. No.: 12/330,164

(22) Filed: Dec. 8, 2008

Related U.S. Application Data
(63) Continuation-in-part of application No. 11/405,396, filed on Apr. 17, 2006.
(60) Provisional application No. 60/671,813, filed on Apr. 15, 2005.

(51) Int. Cl. B29C 47/10

(52) U.S. Cl. 425/130

(57) ABSTRACT

The present invention discloses a multi-gate assembly for creating a composite article, typically including a mold including a closed interior cavity, a first mixing gate in communication with the mold, and at least one iso-based polymer material and at least one poly-based polymer material concurrently fed into the first mixing gate. At least one filler material is fed into a second gate in communication with the first gate, and a composite associated with the iso/poly/filler materials is communicated into the cavity for formation into a three-dimensional article.

### CROSS-REFERENCE TO RELATED APPLICATIONS

This Application is a Continuation-in-part of application Ser. No. 11/405,396 filed on Apr. 17, 2006, and which is in turn claims the priority of U.S. Provisional Patent Application Ser. No. 60/671,813, filed Apr. 15, 2005, for Multi-Gate Reaction Injection Assembly for Use with a Closed Mold for Mixing and Setting ISO and Poly Fluid Based Polymers with One or More Aggregate Filler Material.

### FIELD OF THE INVENTION

The present invention relates generally to multi-reaction injection of polymeric components into a mixing gate and for subsequent introduction into a mold cavity. More specifically, the present invention teaches a first stage injection and intermixing (in a first mixing head) of dedicated iso and poly fluidic components. A second and separate mixing gate is incorporated downstream from the first mixing gate, for the introduction of one or more filler materials, supplied in either a fluidic and/or granular (or other sized particulate) form.

In a preferred embodiment, the first and second mixing gates are incorporated into an integral body which also includes a mold cavity, into which the collective mixture is deposited following admixing. The filler hoppers can be provided as one or more volumes of an aggregate filler, either fluidic, powder or granulate based, the desired material composition being fed (such as by vacuum, injection or free/gravity flow) into the second gate and, following mixing therewith into the previously admixed iso/poly soup, is fed into the closed mold at which point a desired heat and pressure application ensues in order to create the desired part.

The ability to intermix one or more filler materials, in a succeeding gate following the intermixing of the poly and iso fluid materials, greatly expands the possible combinations of material content associated with parts produced by the reaction injection molding process. At the same time, the multi-gate mixing assembly minimizes the instances of clogging of the initial mixing gate, such as which is incidental with attempts to mix, at a single gate both the iso/poly components and the separate filter materials.

### BACKGROUND OF THE INVENTION

The prior art is well documented with examples of foamable and plasticized compositions constructed of one or more plasticized materials and including such as a composite or filler material. The objective is to create a three-dimensional and structural article exhibiting a given material consistency for a given application.

A first example drawn from the prior art is set forth in Maruyama et al., U.S. Pat. No. 6,322,344, and which teaches an injection molding apparatus for creating a multi-layered article. A mold includes a cavity provided with a cavity and a hot runner block. First and second injection cylinders are accessible to the mold cavity via associated resin flow passages for connecting an inside of the second injection cylinders and the cavity.

Czaplicki et al., U.S. Pat. No. 6,787,579, teaches a two-component (epoxy/amine) structural foam in place material, and by which the epoxy component is cross linked through a polymerization reaction catalyzed by the amine formulation. A reactive mixture or exothermic reaction is created between the epoxy component and the amine component when combined. The heat generated by the exothermic reaction softens a thermoplastic shell of a blowing agent formulated within the thermoplastic shell of the blowing agent to expand from the heat generated by the exothermic reaction.

U.S. Pat. No. 4,491,553, issued to Yamada et al., teaches a method for producing a filler loaded thermoplastic resin composite by mixing a thermoplastic resin and filler, and which is applied to a molding machines such as extrusion and injection molded machines, without the occurrence of segregation between the resin and filler. Perez, U.S. Pat. No. 6,323,251, teaches a thermoplastic/thermoset hybrid foam by which the thermoset forms a discontinuous phase in a continuous thermoplastic phase.

Muenz et al., U.S. Patent Application Publication No. 2004/0266899, teaches an expandable thermosettable composition containing at least one epoxy resin, at least one finely divided thermoplastic polymer powder, at least one blowing agent, at least one curing agent, and at least one filler suitable for the production of thermosetting laminated bodies with a tacky surface. The expandable thermosettable compositions are also suitable for the production of thermosetting, thermally expanded shaped articles for reinforcing hollow structural members by the injection molding process.

U.S. Pat. No. 4,474,900, issued to Dominguez, teaches reaction injection molded elastomers derived from high molecular weight amine terminated, polyethers and/or high molecular weight polyols, a chain extender, a polyisocyanate and an epoxy modified filler material. The reaction injection molded (RIM) elastomers of this invention are useful, for example, as automobile body parts.

Finally, Kudert U.S. Pat. No. 4,946,365 teaches an apparatus for injection molding and blow molding articles such as containers exhibiting walls with multiple plies of different polymers (see in particular column 7, line 65 et seq). There are no mixing gates in Kudert, rather the mixing gates 595 and 440 referenced are in fact individual feed channels for communicating discrete polymer materials in the formation of distinct plies associated with a desired container.

### SUMMARY OF THE INVENTION

The present invention discloses a multi-gate assembly for creating a composite article, typically occurring within a mold including a closed interior cavity. As previously described, the multi-gate assembly provides for intermixing of iso/poly fluidic components at a first mixing gate location, followed by the introduction and admixing of one or more filler components, at a second downstream located gate and in order to avoid material clogging at the initial gate.

An integrally defined body includes a first mixing gate, at least one iso-based polymer material and at least one poly-based polymer material being concurrently fed from separate reservoirs, such as by injection, by separate conduits extending into the first mixing gate. At least one filler material is fed into a second mixing gate, also located in the integral body downstream from the first mixing gate. The filler materials are provided in either a fluidic and/or granular (or other sized particulate) form, the latter exhibiting an individual diameter in a range of between ½ to 5 millimeters, and which can be constructed of either of an organic or inorganic based material.

The filler material can be stored within hoppers in communication with the second mixing gate and can be fed (such as by vacuum, injection or free/gravity flow) into the second gate, this following mixing therewith into the previously admixed iso/poly components (i.e. soup). The combined material is then fed into a closed mold defining a further portion of the integral body, at which point a desired heat and pressure application ensues in order to create the desired part.

As previously described, the ability to intermix one or more filler materials, in a succeeding gate following the intermixing of the poly and iso fluid materials, greatly expands the possible combinations of material content associated with parts produced by the reaction injection molding process associated with the iso/poly/filler materials. This results in the ability to forma the mixture into any desired three-dimensional article.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is a first example, in cutaway, of a closed reaction injection mold assembly including a first iso/poly mixing gate, combined with a succeeding gate for intermixing one or more aggregate filler materials and prior to depositing within a negative cavity associated with the mold;

FIG. 2 is a further example of a closed mold assembly exhibiting a further configuration for intermixing iso/poly materials with a specified aggregate filler;

FIG. 3 is a further example of a closed mold and illustrating a still further configuration for intermixing iso, poly, and filler based materials:

FIG. 4 illustrates a yet further example of a closed mold arrangement and by which a filler material is intermixed at a second gate subsequent to a mixing stream gate associated with the poly and iso based materials;

FIG. 5 is an illustration of a mold assembly according to a yet further preferred embodiment and including volume holding reservoirs associated with the poly and iso based materials, in combination with first and second individual aggregate filler reservoirs, for supplying successive and communicating first and second mixing gates associated with a closed mold;

FIG. 6 is a variant illustration of a closed mold such as illustrated in FIG. 5 and further showing the arrangement of the first iso/poly mixing gate, and second succeeding filler mixing gate according to the present invention;

FIG. 6A is an illustration of a poly/iso and filler combined three-dimensional material produced according to any of the reaction injection molding processes set forth in the present invention;

FIG. 7 is a further illustration of closed mold assembly, including iso/poly and filler mixing gates arranged in a further configuration and in order to supply a reaction injection material into the closed mold;

FIG. 8 is a still further example of an arrangement for multi-gate mixing and injection of iso/poly and filter materials;

FIG. 9 is a yet further example of a gating and mixing application according to the present invention; and

FIG. 10 is a perspective illustration of multi-gate mixing arrangement according to the present invention and by which dedicated iso and poly fluids comprising a first mixing operation, with one or more separate filler hoppers communicating with a second downstream gate in order to introduce and intermix with the initially mixed iso/poly mixture such as a vacuum drawn collection of fluid and/or granulate/particulate material.

### DETAILED DESCRIPTION OF THE PREFERRED EMBODIMENTS

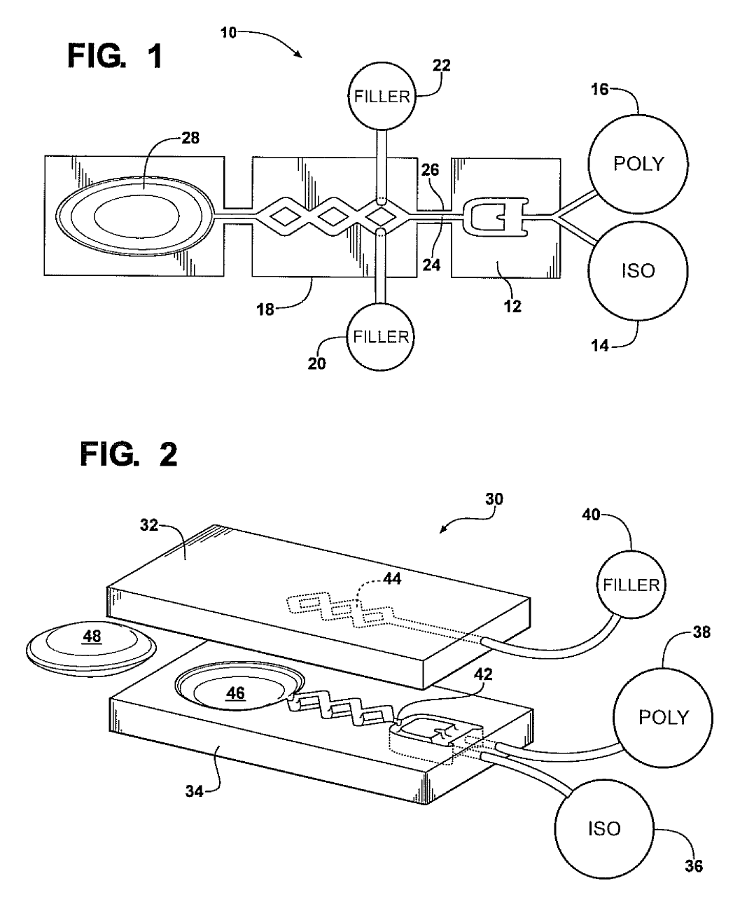

Referring now to FIG. 1, a first example, in cutaway, is shown at 10 of a closed reaction injection mold assembly including a first iso/poly mixing gate, combined with a succeeding gate for intermixing one or more aggregate filler materials and prior to depositing within a negative cavity associated with the mold.

The objective of the present invention (and as will be described in reference to each of the succeeding several embodiments) is the concurrent mixing, in a first gate 12, of an iso based material 14, such as provided in a heated state drawn from a fluidic reservoir, and which is combined with a poly based plasticized/polymer material 16, in turn drawn from a second reservoir.

The iso and poly based materials are preferably co-injected, in their fluidic state, into a mixing head 12 associated with a first common gate 12 incorporated into the reaction injection molding process. The iso and poly based components are selected, respectively, from suitable sub-class materials drawn from the general classification of polymers, this being further defined as including any of a class of natural or synthetic substances composed of macromolecules that are multiples of monomer based molecules.

Specifically, chains of unbranched or branched monomers (e.g., styrene based materials and the like) may be cross-linked or chained in two or three dimensions to form desired poly macromolecules. Additional types of synthetic organic polymers include many plastics, including polyethylene, nylons, polyurethanes, polyesters (e.g., vinyl or PVC), and synthetic rubbers. Further, silicone based polymers, those exhibiting an inorganic backbone of silicone and oxygen atoms and organic side groups, are among the most important mixed organic-inorganic compounds.

First mixing gate 12, as generally illustrated, includes such structure as a mixing impeller or like structure which facilitates intermixing of the liquid or fluidic state iso/poly materials in a suitable fashion and in order to create a substantially homogenous composition prior to communication of the composition into the associated mold. Other types of structure associated with the first gate 12 and for intermixing the fluidic components 14 and 16 may include any of a range of available elements for creating the desired and homogenized fluidic combination.

Referenced generally at 18, see again FIG. 1, is a second gate 18, and within which at least one filler material, and which is referenced by first and second filler materials 20 and 22, are co-introduced into the gate 18 in combining and communicating fashion with a homogenous liquid 24 combining the components of the previously intermixed iso 14 and poly 16 materials. The liquid 24 is conveyed from the first gate 12 through a passageway 26 communicating with the second gate 18.

The filler material(s) are selected from any range of fluid, powder or aggregate/particulate based organic and inorganic materials, and in particular such recyclable materials, the selection of which is predicated upon the desired end-product characteristics (e.g., strength, weight) of the product produced within the mold. Examples of filler materials 20 and 22 include gravel, sand, wood/cellulose based chips and shavings, as well as wide range of organic and/or inorganic materials.

In preferred variants, the present invention renders possible the mixing of different fillers of an aggregate nature and ranging from one-half a millimeter to five millimeters or greater in diameter. An associated mold assembly produces an end-product article 28, after a desired application of heat and pressure, the article incorporating the combination of the iso and poly components, combined with the filler material(s) intermixed therewith.

Referring now to FIG. 2, a further example is illustrated generally at 30 of a closed mold assembly exhibiting an integrally defined mold and multi-mixing gate body according to a further configuration for intermixing iso/poly materials with aggregate filler. FIG. 2 provides a more detailed illustration of a closable/closed mold (see exploded halves 32 and 34) associated with the reaction injection molding process.

Associated input locations for the iso, poly, and filler materials are illustrated respectively at 36 and 38 (associated with mold half 34) and at 40 (associated with mold half 32). The iso 36 and poly 38 materials are combined at first gate 42, the resulting homogenized material stream again being intermixed through braided-like intertwining passageways in admixing fashion with the filler material 40, this illustrated as second communicating gate 44.

At 46, the combined mixture sets within an associated cavity in the mold and, after its desired period of pressure induced heating and curing, is ejected as a finished part at 48. As with FIG. 1, and each of the succeeding illustrations, the arrangement and structure of the first mixing gate and second mixing is within the discretion of one of ordinary skill in the art and may include impeller driven mixers, co-extruders, and the like.

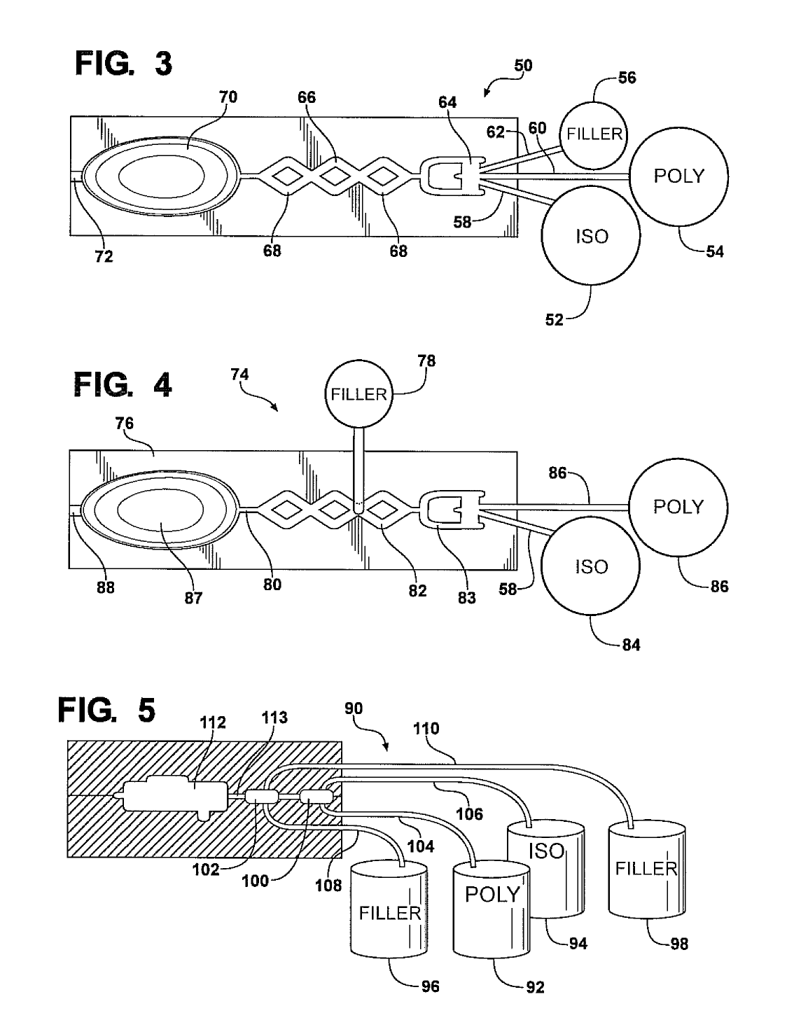

FIG. 3 illustrates a further example 50 of a closed mold according to a still further configuration of the present invention and for intermixing iso 52, poly 54, and filler 56 based materials and their associated feeder inputs 58, 60 and 62, respectively. The example 50 illustrated includes intermixing, in a single common gate 64, all three components. The iso 52 and poly 54 based materials again typically include first and second fluidic based materials, the filler material 56 further including such as an organic/inorganic granulate material exhibiting individual particulate diameters of ½ to 5 millimeters.

The common mixing gate 64 admixes together a resultant composite material and which is fed in a particular manner through a conduit assembly, see bends and windings 66 and 68, following which the completely admixed iso/poly/filler material is transmitted to an enclosed mold 70 during which the desired product is formed and defined, such as through the additional application of heat and pressure. Access hole 72 is also provided on a backside location of the integral body and is in communication with the mold 70, for purposes of assisting in the formation of the three dimensional article, such as through the provision of ventilation and cooling, and prior to the part being discharged. The access hole 72 is also representative of an outlet location of the integrally defined mold body, and by which the part produced (not shown) can be removed from the mold. This can also occur by providing the integral body 76, or at least the part enclosing the mold component 70, as assembled halves (also not shown) and by which the body is opened to remove the completed part in instances in which the access location is too small for all for removal of the completed product.

FIG. 4 illustrates at 74 a yet further example of an integral defining and closed mold arrangement 76 and by which a filler material 78 is intermixed (again in either a fluidic, powderized or granulate form) at a second gate 82, subsequent to an initial mixing/stream gate 83 associated with iso 84 and poly 86 based materials. The initial gate 83 is provided as a uniquely configured mixing head designed for admixing the iso/poly components and the second gate 82, as illustrated by this embodiment, includes a plurality of communicating and winding portions to homogenize the mixture of the iso 84 and poly 86 components with the admitting filler component 78.

The completely admixing combination of iso/poly/filler components is then communicated through passageway 80 into enclosed mold portion, see at 87, at which point the mixture is heated and cured. End communicating aperture is again shown at 88 and is representative of an outlet of the mold assembly, the function of which is largely as previously described in reference to aperture 72 discussed in FIG. 3. As is also known, additional variants may include other forms of molding or extrusion of the admixed compositions within the desires of one of skill in the art.

Referring now to FIG. 5, an illustration is generally shown at 90 of a mold assembly according to a yet further preferred embodiment. The mold assembly 90 includes volume holding reservoirs corresponding to poly 92 and iso 94 based materials, in combination with first 96 and second 98 individual aggregate filler reservoirs, for supplying successive and communicating first 100 and second 102 mixing gates associated with a closed mold.

The poly material 92 is fed by line 104, the iso material 94 by line 106, each of which communicates with the first gate 100. The homogenously combined mixture is further admixed with the filler material 96, through communicating line 108 and, optionally, another the filler material 98 through line 110, into the second gate 102 for admixture with previously admixed and downstream communicated iso/poly combination. A uniquely configured cavity 112 defined within the integrally defined mold body, and in communication with the second gate 102 via a further passageway 113 receives a determined volume of the admixed material for treatment/curing and prior to issuing a finished part.

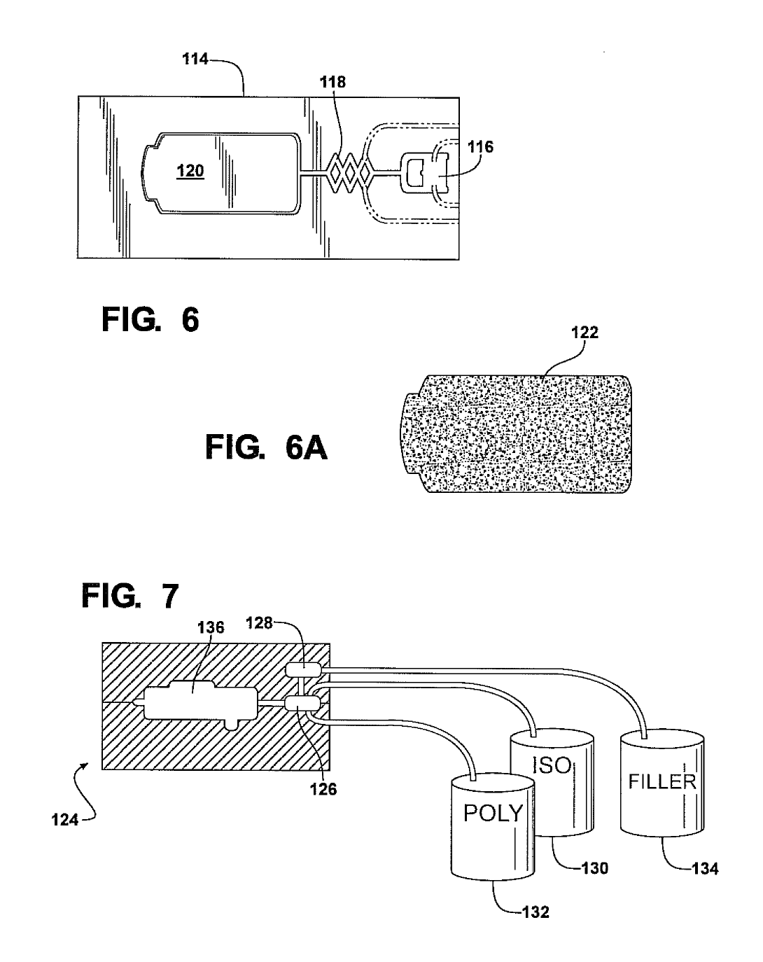

As is further shown in FIG. 6, a variant is illustrated at 114 of a closed mold, such as previously illustrated in FIG. 5, and further showing the arrangement of the first iso/poly mixing gate 116, and second succeeding filler mixing gate 118. A cavity 120 communicates with an outlet of the second mixing gate 118 in order to admit and form a volume of the combined material into a desired part. The illustration shown at 114 can be representative of an open ½ of an integral mold body again incorporating the two successive mixing gates and the mold.

FIG. 6A is a representative illustration, at 122, of a poly/iso and filler combined three-dimensional material produced according to any of the reaction injection molding processes set forth in the present invention. It is important to note that the shape 122 is representative of one potential article which can be created utilizing succeeding mixing gates, the material construction and associated mechanical/chemical properties of the resultant three-dimensional part further being modifiable within the scope of the present invention. This again contemplates tie utilization of poly and iso injected fluidic components into a first mixing gate incorporated into an integral tool body, the filler component (or components) being separately injected vacuum drawn, and/or gravity fed for admixing within a second downstream located gate. This further enables the ability to mix different granulate/particulate based fillers at a second gate, such exhibiting an average diameter ranging from ½ millimeter to upwards of 5 millimeters in diameter, and without clogging the initial gate at which the iso/poly materials are mixed.

Referring now to FIG. 7, a further illustration, generally shown at 124, is shown of closed mold assembly according to a further desired arrangement and again including iso/poly 126 and filler 128 mixing gates arranged in a further configuration and in order to supply a reaction injection material into a closed mold 136. Iso 130 and poly 132 materials are fed into the first gate 126, whereas selected filler material 134 is concurrently fed into second gate 128.

The arrangement of FIG. 7 differs slightly from those previously disclosed in that the filler is passed through a separate gate (at 128) before admixing at a downstream location with the first gate 126, this avoiding the primary concern of clogging of an initially introduced filler granulate at the first gate mixing head, while at the same time allowing for admixing in a fashion in which the first gate 126 defines a second mixing step. As with the earlier described embodiments, cavity 136 receives and cures the admixed combination of material and prior to issuing a finished part.

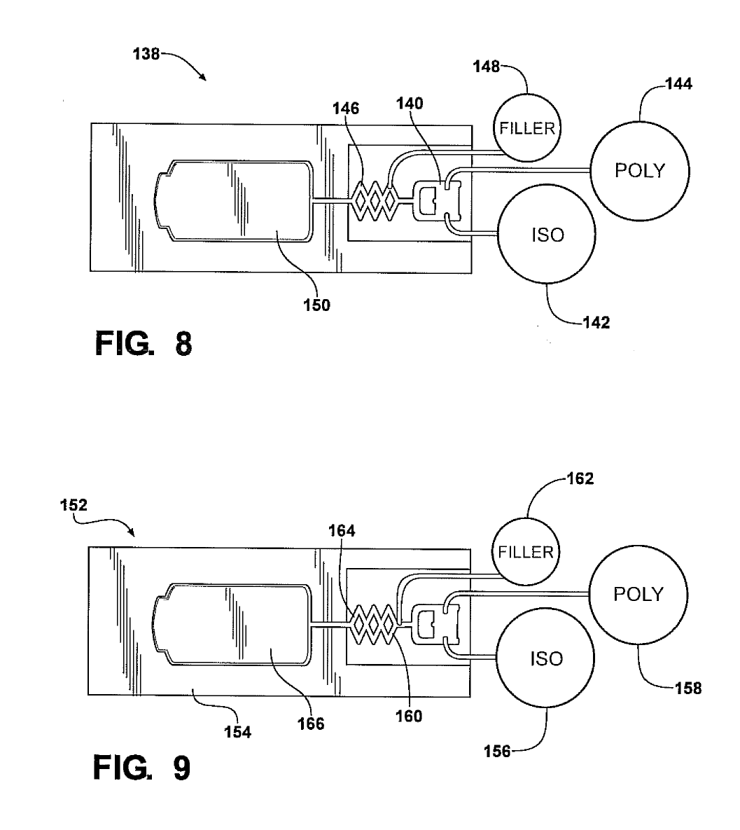

FIG. 8 illustrates at 138 a still further example of another arrangement for multi-gate mixing and injection of iso/poly and filter materials. Initial mixing gate 140 combines the fluidic contents of iso-based material 142 and poly-based material 144. Communicating second gate 146 (again see unique mixing pattern) combines the fluidic material with an evenly distributed admixture of filler material 148 (such as again provided in any one ore more of a fluidic, particulate, and even gaseous stage, and prior to the desired volume of the multi-component and completely admixed material being fed into cavity 150 for subsequent heat and compression for molding into the desired part.

Referring to FIG. 9, a yet further example is shown generally at 152 of a gating and mixing application according to another related embodiment of the present invention. A one piece mold body 154 includes a first mixing gate 160 (at an inlet side) for combining the desired iso 156 and poly 158 materials, concurrent with the filler material 162 being admixed through communicating second gate 164. The combined mixture is then inserted into the cavity 166 and in order to form the desired part.

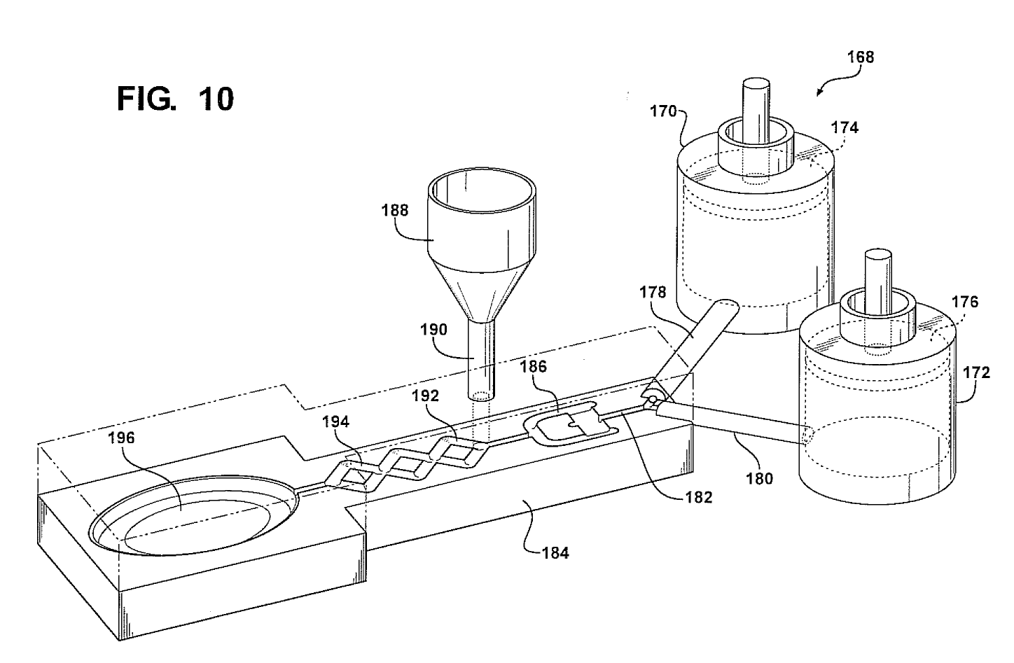

Finally, and referring to FIG. 10, a perspective illustration is shown at 168 of multi-gate mixing arrangement according to the present invention, and by which dedicated iso and poly fluids are incorporated into designated feed reservoirs shown at 170 and 172, respectively. The feed reservoirs 170 and 172 as shown each exhibit a generally cylindrical configuration and each contains a desired volume of the iso and poly material.

Each reservoir further includes a downwardly actuating plunger, see at 174 and 176, respectively. The plungers are downwardly actuated to forcefully discharge a determined volume of each iso and poly fluid, through conduits 178 and 180, and into a first mixing head which is configured at a generally entrance location of an integrally defined body 184.

The confluence of the iso 178 and poly 180 supply conduits at the first mixing gate (referenced as mixing intro passageway 182 leading into an initial mixing location 186) and which constitutes a first mixing operation in which the fluidic components are evenly intermixed. The first mixing head incorporates a passageway which is profile defined in the integral body for effectively and homogenously intermixing the iso and poly components introduced in the first mixing gate.

A filler hopper is further shown at 188, it being understood consistent with the description previously given that any plurality of filler hoppers can be utilized. The hopper 188 contains a filler materials, which is provided in either a fluidic and/or granular (or other sized particulate) form, the latter exhibiting in one non-limiting example an individual diameter in a range again in a described range of between ½ to 5 millimeters, and which can be constructed of either of an organic or inorganic based material. Such materials are again understood to include any type of (inorganic) polymeric based granule, as well as organic stone, wood, metal and ceramic shards, granules or other desired sized particulates.

An outlet conduit 190 extending downwardly from the hopper 188 is in communication with an inlet location of a second mixing gate 192, this in order to introduce and intermix the filler material with the initially mixed iso/poly mixture, the latter being fed in communicating fashion through the passageway 186 linking the first mixing head to the second mixing location 192. As with previously described embodiments, the filler material can be supplied to the second mixing head 192, through the discharge or outlet conduit 190, employing any of a vacuum drawing process, as well as potentially a pressurized injection process (similar to that employed in the introduction of the iso and poly components into the first mixing gate) or even free flow/gravity supply of the filler material.

Subsequent to introduction at the location 192 associated with the second gate, the filler material(s) are intermixed with into the previously admixed iso/poly soup, such as along a further braiding-like mixing profile shown at 194. The further mixing profile 194 is configured for evenly admixing the filler material(s) with the previously admixed and advanced iso/poly soup. As previously stated, the ability to intermix one or more filler materials, in a succeeding gate following the intermixing of the poly and iso fluid materials, greatly decreases the incidence of clogging which can result from attempting to introduce the filler component directly into the first mixing gate along with the iso and poly components.

The combined material is then fed into a closed mold 196 defining a further portion of the integral body 184, at which point a desired heat and pressure application ensues in order to create a part exhibiting a desired three dimensional configuration. It is further understood that variances in both the admixed composition introduced into the closed mold, as well as the conditions of the mold temperature/pressure, are reflected in the composition and material properties, characteristics of the item produced.

Having described my invention, other and additional preferred embodiments will become apparent to those skilled in the art to which it pertains and without deviating from the scope of the appended claims.

I claim:

1. A multi-gate assembly for creating a composite molded article, comprising:
an integral body having a three dimensional shape and size and including a first mixing gate communicable with an entrance location of said body said body further including a second mixing gate located downstream from and communicating with said first gate, said second mixing gate communicating with a mold cavity defined at a further location within said body;
an iso-based polymer material and a separate poly-based polymer material concurrently communicated to and admixed together within said first mixing gate; and
at least one filler material communicated to said second gate and admixing with said previously admixed iso/poly material advanced from said first gate, a composite comprised of said iso/poly/filler materials being advanced from said second gate into said mold cavity for subsequent formation into a three-dimensional article.

2. The assembly as described in claim 1, each of said iso and poly based materials having a fluidic composition.

3. The assembly as described in claim 2, said iso and poly fluids being incorporated into first and second feed reservoirs, each exhibiting a generally cylindrical and further including a downwardly actuating plunger for forcefully discharging a determined volume of each iso and poly fluid through conduits extending from said reservoirs and connecting to a mixing head associated with said first mixing gate.

4. The assembly as described in claim 1, said filler material further comprising at least one of a fluid, powder or granulate.

5. The assembly as described in claim 1, said filler material further comprising a particulate material exhibiting an average individual diameter in a range of between ½ to 5 millimeters.

6. The assembly as described in claim 1, said filler material including at least one of an organic or inorganic based material.

7. The assembly as described in claim 1, further comprising a first filler material reservoir and a second filler material reservoir, said first and second filler materials being fed into said second gate.

8. The assembly as described in claim 7, each of said filler material reservoirs further comprising a hopper, an outlet conduit extending downwardly from said hopper in communication with an inlet location of said second mixing gate.

9. The assembly as described in claim 8, further comprising at least one of a vacuum, injection or gravity flow process for communicating and admixing said filler material with said second mixing gate.

10. The assembly as described in claim 3, said body further comprising a passageway profile defined in said integral body in communication with said mixing head and for effectively and homogenously intermixing said iso-based and poly-based materials.

11. The assembly as described in claim 10, a further mixing profile forming an additional component of said second mixing gate and configured for evenly admixing said filler material(s) with said previously admixed and advanced iso/poly components.

12. A multi-gate assembly for creating a composite molded article, comprising:
an integral body having a three dimensional shape and size and including a first mixing gate communicable with an entrance location of said body, said body further including a second mixing gate located downstream from and communicating with said first gate, said second mixing gate communicating with a mold cavity defined at a further location within said body;
an iso-based polymer material and a separate poly-based polymer material concurrently communicated to and admixed together within said first mixing gate, each of said iso and poly based materials having a fluidic composition; and
at least one filler material communicated to said second gate and admixing with said previously admixed iso/poly material advanced from said first gate, said filler material further comprising at least one of a fluid, powder or granulate, a composite comprised of said iso/poly/filler materials being advanced from said second gate into said mold cavity for subsequent formation into a three-dimensional article.

13. The assembly as described in claim 12, said iso and poly fluids being incorporated into first and second feed reservoirs, each exhibiting a generally cylindrical and further including a downwardly actuating plunger for forcefully discharging a determined volume of each iso and poly fluid through conduits extending from said reservoirs and connecting to a mixing head associated with said first mixing gate.

14. The assembly as described in claim 12, said filler material further comprising a particulate material exhibiting an average individual diameter in a range of between ½ to 5 millimeters.

15. The assembly as described in claim 12, said filler material including at least one of an organic or inorganic based material.

16. The assembly as described in claim 12, further comprising a first filler material reservoir and a second filler material reservoir, said first and second filler materials being fed into said second gate.

17. The assembly as described in claim 16, each of said filler material reservoirs further comprising a hopper, an outlet conduit extending downwardly from said hopper in communication with an inlet location of said second mixing gate.

18. The assembly as described in claim 17, further comprising at least one of a vacuum, injection or gravity flow process for communicating and admixing said filler material with said second mixing gate.

19. The assembly as described in claim 13, said body further comprising a passageway profile defined in said integral body in communication with said mixing head and for effectively and homogenously intermixing said iso-based and poly-based materials.

20. The assembly as described in claim 19, a further mixing profile forming an additional component of said second mixing gate and configured for evenly admixing said filler material(s) with said previously admixed and advanced iso/poly components.
